(19) United States
(12) Patent Application Publication
(10) Pub. No.: US 2017/0220946 A1
(43) Pub. Date: Aug. 3, 2017

(54) ADDITIVE PRINT SUCCESS PROBABILITY ESTIMATION

(71) Applicant: Shane Ray Thielen, Bennington, NE (US)

(72) Inventor: Shane Ray Thielen, Bennington, NE (US)

(21) Appl. No.: 15/013,791

(22) Filed: Feb. 2, 2016

(51) Int. Cl. G06N 7/00; B33Y 50/00; B33Y 30/00; B29C 67/00

(52) U.S. Cl. CPC G06N 7/005; B29C 67/0088; B33Y 50/00; B33Y 30/00

(57) ABSTRACT

A centralized computer system estimates a failure probability to print a 3D model by analyzing the 3D model to identify certain predetermined features and receive an indication of print failure. Based on correlated analyses and indications of success or failure received by a sample of users printing various 3D models having different combinations of features, the centralized computer system produces and maintains a data structure of features and success rates. Subsequently, the centralized computer system may receive a 3D model analysis, compare the 3D model analysis to the data structure to determine an estimated success probability, and report the estimated success probability to the user that submitted the 3D model.

### FIELD OF THE INVENTION

Embodiments of the inventive concepts disclosed herein are directed generally toward additive 3D printing, and more particularly to a method for estimating probable print success.

### BACKGROUND

Consumer grade additive deposition 3D printers vary widely as to print consistency and reliability. Even advanced, generally reliable 3D printers are subject to print failures. Certain properties of a 3D model, print medium, and features of the 3D printer can substantially impact the probability of a print success.

Consequently, it would be advantageous if an apparatus existed that is suitable for estimating the probability of a print success in advance of actual printing.

### SUMMARY

In one aspect, embodiments of the inventive concepts disclosed herein are directed to a method for estimating a success probability by analyzing a 3D model to identify certain predetermined features and receive an indication of print success. A centralized computer system receives the analysis and whether or not the 3D model successfully printed. Based on correlated analyses and indications of success or failure received by a sample of users printing various 3D models having different combinations of features, the centralized computer system produces and maintains a data structure of features and success rates. Subsequently, the centralized computer system may receive a 3D model analysis, compare the 3D model analysis to the data structure to determine an estimated success probability, and report the estimated success probability to the user that submitted the 3D model.

In a further aspect, the centralized computer system may further track print medium features such as the type of plastic filament, additional additives that alter features of the plastic filament, print temperature, etc., and features of the 3D printer.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a computer system for implementing embodiments of the inventive concepts disclosed herein;

FIG. 2 shows perspective view of a 3D model;

FIG. 3 shows an environmental view of a 3D printer;

FIG. 4 shows an environmental view of a 3D model oriented on a 3D printer print bed;

FIG. 5 shows an embodiment of a user interface according to aspects of the inventive concepts disclosed herein;

FIG. 6 shows a flowchart of a method for compiling data and providing an estimate of print success probability according to embodiments of the inventive concepts disclosed herein;

FIG. 7 shows a flowchart of a method for analyzing a 3D model to provide an estimate of print success probability according to embodiments of the inventive concepts disclosed herein;

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a′ and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a system and method for estimating the probability of a 3D model failing to print based on features of the model and system with reference to a community dataset of print successes and failures.

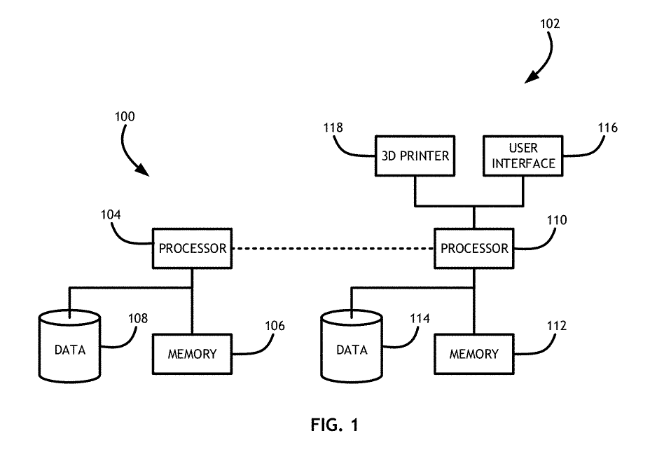

Referring to FIG. 1, a block diagram of a computer system for implementing embodiments of the inventive concepts disclosed herein is shown. In some embodiments, the system comprises a remote computer system 100 and a local computer system 102. Generally, the local computer system 102 loads a 3D model and the remote computer system 100 provides an estimated print success probability to the local computer system 102; the local computer system 102 does not require the remote computer system 100 to function.

In some embodiments, the remote computer system 100 comprises a processor 104 connected to a memory 106 for storing processor executable code and a data storage element 108 for maintaining a database associating various features of 3D models, features of various print media, properties of a 3D printer, and properties of a print process with print success or failure. The remote system processor 104 analyzes the database to produce a multidimensional analytical framework for determining an estimated print success probability for a particular 3D model, even when the particular 3D model is unique or otherwise unknown and previously unprinted. The processor 104 may continuously or periodically update the multidimensional analytical framework as new data points are received.

In some embodiments, the remote computer system 100 receives data from a plurality of users to maximize the available dataset. Users may utilize local computer systems 102, each of which supplies data to the remote computer system 100.

The local computer system 102 comprises a processor 110 connected to a memory 112 for storing processor executable code. The processor 110 instantiates a user interface 116 on a display device, allowing a user to load a 3D model. The processor 110 may analyze the 3D model to identify the presents or absence of features in a predefined set of features considered pertinent to success or failure of the print operation. The predefined set of features may change over time as additional features are identified as pertinent or changes to the printing process or the 3D printer render existing features in the set superfluous.

The processor 110 executes a print process utilizing a 3D printer 118 and solicits an indication from the user as to whether or not the print process was successful. The processor 110 then send the 3D model analysis and indication of success or failure to the remote computer system 110 for inclusion in the database. In some embodiments, the local computer system processor 110 may also send properties of the 3D printer 118 and properties of the print process to the remote computer system 100 for inclusion into the database.

Furthermore, the local computer system processor 110 may load a 3D model, for example from a data storage element 114 connected to the processor 110, analyze the 3D model, and send the analysis to the remote computer system 100. The remote computer system 100 then estimates a print success probability based on the 3D model analysis with reference to the multidimensional analytical framework and returns to estimated print success probability to the local computer system 102, which may be displayed on the user interface 116 before the print process is executed.

While FIG. 1 shows a separate remote computer system 100 and local computer system 102, and such configuration is desirable to acquire the largest and most diverse data set, embodiments wherein all of the functions are performed by the local computer system 102 are envisioned. Data may be shared between users using such embodiment via peer-to-peer or other suitable data sharing methodology.

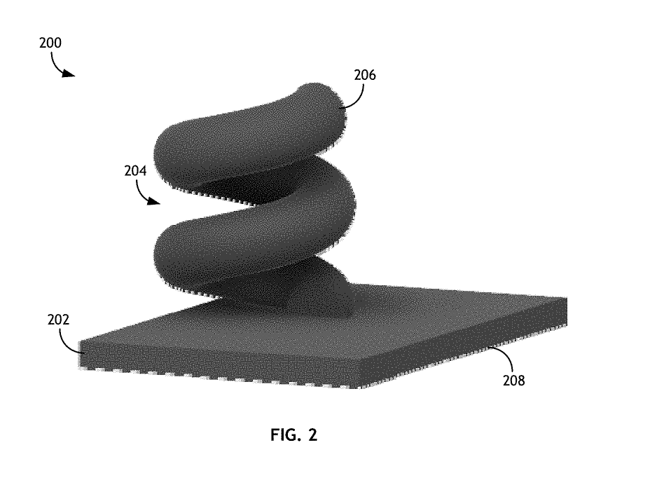

Referring to FIG. 2, perspective view of a 3D model 200 is shown. Embodiments of the inventive concepts disclosed herein include analyses of isolated features of a 3D model 200 that have been identified as pertinent to the probability of successfully printing 3D models. Such features may include, but are in no way limited to, the size and orientation of any flat surfaces 202, the size of any vertical gaps 204 (distances in the Z direction between portions of the model that may or may not be filed but support material), the radius 206 of various curved portions, the length of extended straight portions 208, height of the 3D model 200, or any other isolated features that may be identified in a 3D model 200.

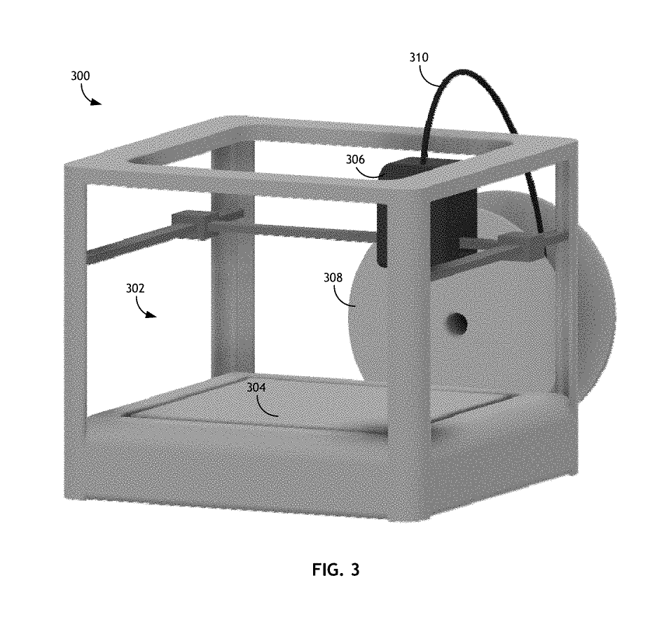

Referring to FIG. 3, an environmental view of a 3D printer is shown. Embodiments of the inventive concepts disclosed herein include analyses of features or properties of a 3D printer 300. Such features may include, but are in no way limited to, the total available build volume 302, especially with respect to the volume of 3D model to be printed, size and calibration of the print bed304, minimum resolution and actual selected resolution of the extruder 306, estimated remaining filament on a spool 308 (the radius of curvature of a filament on a spool decreases as the spool is used; smaller radius of curvature may cause failures in the extruder), and properties of the filament 310 such as the type of plastic or additives to the plastic to create a particular color or change the physical properties of the filament 310. It should be understood that absolute values of any particular property are generally irrelevant; only the effect of such properties on print success are pertinent. For example, the resolution of the extruder 306 is only pertinent in as much as one resolution setting tends to produce a higher probability of a successful print, even if such resolution is lower than the maximum possible for the particular 3D printer 300. Furthermore, embodiments of the inventive concepts disclosed herein are directed generally toward the interrelationship between features of a 3D model, printer properties, and properties of the print process as they affect the probability of a print sucess.

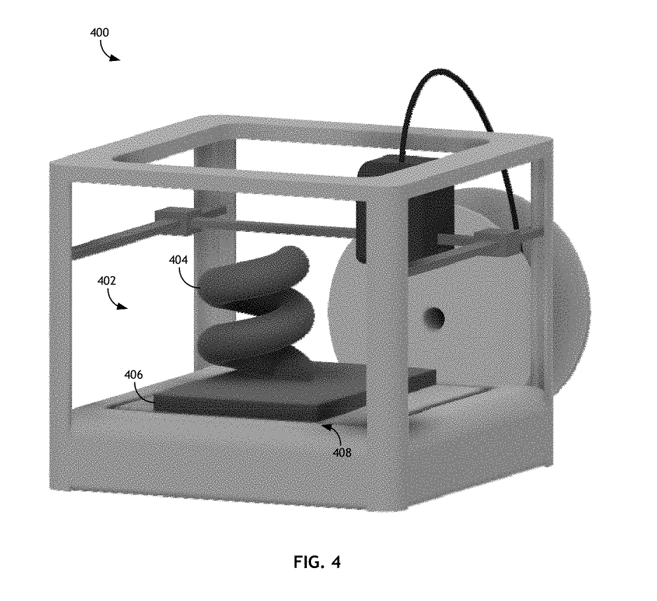

Referring to FIG. 4, an environmental view of a 3D model oriented on a 3D printer print bed is shown. According to some embodiments, the probability of successfully printing a 3D model 404 on a particular 3D printer 400 may depend on certain interrelationships between the 3D model 404 and the 3D printer 400. For example, the location of the 3D model 404 within the build volume 402 and the distance between the base component 406 of the 3D model 404 and the edge 408 of the build volume 402 may materially affect the probability of a successful print. Also, the shape of a base component 406 with respect to a raft on the print bed may also impact the probability of a successful print.

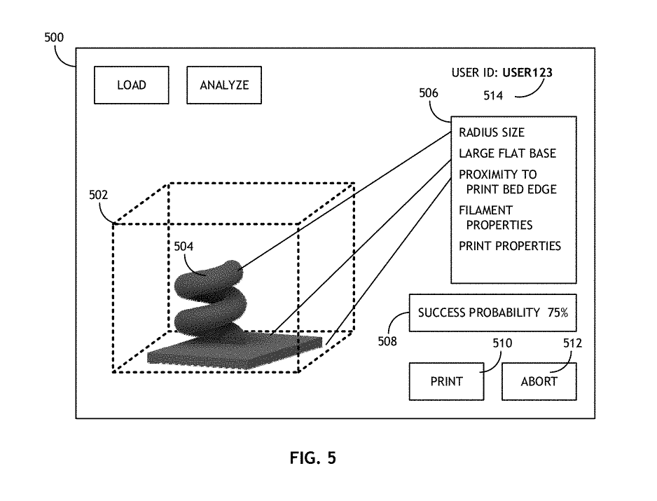

Referring to FIG. 5, an embodiment of a user interface 500 according to aspects of the inventive concepts disclosed herein is shown. In some embodiments, the user interface 500 allows a user to load a 3D model 504 with may be displayed in a virtual build volume 502. The 3D model 504 is analyzed for the existence of predefined features that may affect the probability of a successful print; those features 506 that are found to exist may be listed for the benefit of the user. Such analysis is then processed, locally or remotely, to produce an estimated success probability 508, which is displayed on the user interface 500. The estimated success probability 508 may also account for features of the 3D printer to be used in the print process, selectable features of the print process such as print resolution, properties of the print medium to be used, and other pertinent features that may be identified from time-to-time.

Knowing the estimated success probability 508, the user has the option to print 510 the model. When the print process is complete, the user may indicate either the success or failure of the print process. In some embodiments, failure may be indicated by aborting 512 the print process before completion. In some embodiments, the indication of success or failure may correspond to a subjective satisfaction scale.

The indication of success or failure and the combined feature set of the 3D model and print process are used to build or refine a multidimensional analytical framework associating features in that feature set, alone and in various combinations, with a success rate.

Furthermore, in some embodiments submitted feature sets and corresponding indications of success or failure may be weighted according to the submitting user 514. For example, submissions of a failed print from a user 514 with an abnormally high failure rate may be weighted less heavily during processing; likewise, submissions of a successful print from the same user 514 may be weighted more heavily. In some embodiment, the obverse may also be true: the estimated success probability 508 may be degraded for a user 514 with an abnormally high failure rate.

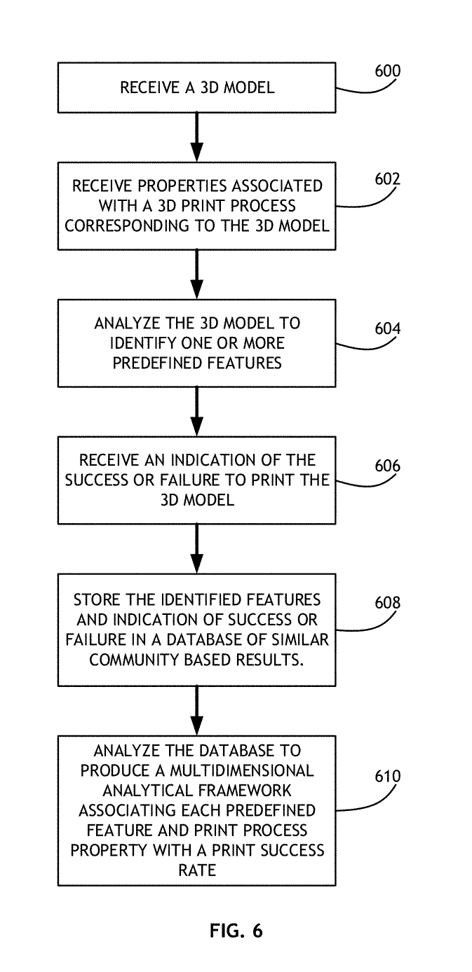

Referring to FIG. 6, a flowchart of a method for compiling data and providing an estimate of print success probability according to embodiments of the inventive concepts disclosed herein is shown. In some embodiments, a processor receives 600 a 3D model intended for a print process. The processor then analyzes 604 the 3D model to identify one or more features in a predefined set of features known to impact the probability of a successful print process. The process may also receive 602 a set of properties associated with the 3D printer, print process, and print medium. Alternatively, the processor may receive a prepared feature set prepared by a local computer system that will actually perform the print process.

Once the print process is actually performed, the processor receives 606 an indication of success or failure from the user. The feature set and indication of success or failure are stored 608 in a database and analyzed 610 to produce a multidimensional analytical framework associating each predefined feature and print process property with a print success rate.

In some embodiments, analyzing 610 the database comprises isolating individual features to determine the contribution of that feature to the overall success rate; for example, such contribution may comprise the average success rate of all print processes including the isolated feature; alternatively, the contribution may comprise a weighted average of the success rate of a set of print processes comprising the isolated feature and a random sample of other features. A processor analyzing 610 the database may iteratively perform a similar process to determine the contribution of various combinations of features. The contribution of combinations of feature may supersede the contribution of individual features. The multidimensional analytical framework may comprise the contribution factor for each feature and every combination of features, or some subset of those contribution factors. The multidimensional analytical framework may be organized into a hierarchy to apply only the highest level contributions (those including the greatest number of features), or to weight the highest level contributions more heavily than lower level contributions. Multiple contributions from various features or combinations of features are combined to arrive at an estimated success probability for an otherwise unknown 3D model.

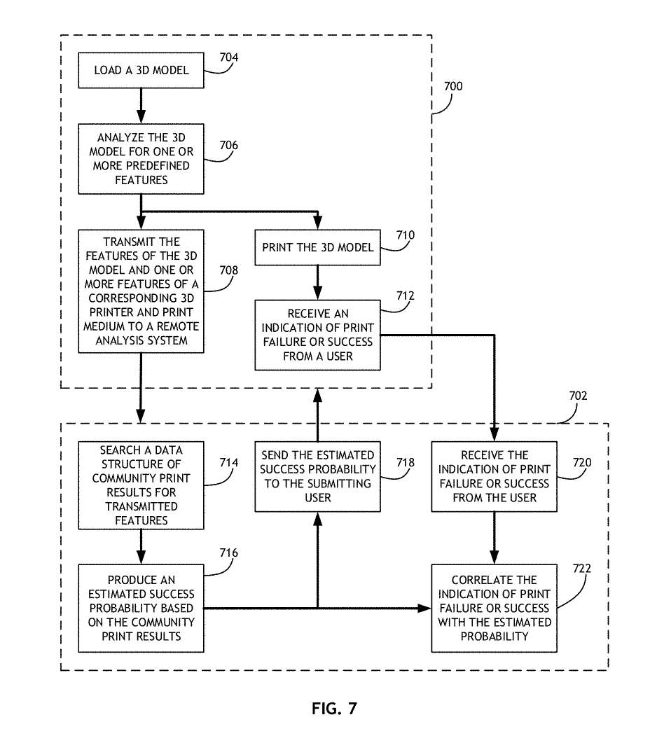

Referring to FIG. 7, a flowchart of a method for analyzing a 3D model to provide an estimate of print success probability according to embodiments of the inventive concepts disclosed herein is shown. In some embodiments, a bifurcated system of a local computer process 700 and a remote computer process 702 interact to provide an estimated success probability based on user submitted success rates of print processes for various 3D models with various print constraints.

In some embodiments, a local computer process 700 loads 704 a 3D model and analyzes 706 the 3D model to identify one or more predefined features pertinent to the success rate of a print process. The local computer process 704 then transmits 708 the 3D model analysis, one or more features of the 3D printer, one or more properties of the print process, and one or more features of the print medium to a remote computer process 702 to determine an estimated success rate.

The remote computer process 702 receives a data set comprising the 3D model features, 3D printer features, print process properties, and print medium features, and searches 714 a data structure correlating various features and properties to print success rate contribution factors. The data structure may comprise a multidimensional analytical framework associating various combinations of features to community derived contribution factors. Applicable contribution factors may be combined to produce 716 an estimated probability of print success. The estimated probability of print success is then sent 718 to the local computer process 700 where it is displayed to a user. The user then has the option to instruct the local computer process 700 to print 710 the 3D model; during or at the conclusion of the print process, the local computer process 700 receives 712 an indication of success or failure from the user which is then received 702 by the remote computer process 702. The indication of success or failure is correlated 722 to the previously transmitted data set and incorporated into the data structure to periodically or continuously update the contribution factors.

While embodiments described include a local computer process 700 and a remote computer process 702, all of the functions may be performed by the local computer process 700. In such embodiment, the system may be limited to data gathered from a single local user, or a remote system may provide a compilation of data to the local computer process 700.

While some described embodiments specify a print success probability, it should be understood that a print success probability may be represented as a d=failure rate. Furthermore, embodiments may positively utilize both success rates and failure rates when determining one or more contribution factors. Likewise, certain combinations of features, either of a 3D model or 3D printer or both, may operate synergistically such that combinations of features may provide a higher print success rate than the individual features in isolation. Such relationships should be statistically identifiable with a large enough data set and used to refine the estimated print success probability.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages. The form herein before described being merely an explanatory embodiment thereof, it is the intention of the following claims to encompass and include such changes.

1. A method for estimating a print success probability of a new 3D model comprising:
receiving a plurality of data sets, each of the plurality of data sets comprising a list of features identified in a particular 3D model and an indication of whether or not the particular 3D model printed successfully;
analyzing the plurality of data sets to define a plurality of contribution factors, each contribution factor comprising a value indicating an impact of the corresponding feature on a success rate when printing a 3D model including the corresponding feature;
receiving a new 3D model data set comprising a list of features identified in the new 3D model;
compiling a set of contribution factors, each corresponding to one or more features in the new 3D model data set; and
determining an estimated probability of print success based on the compiled set of contribution factors.

2. The method of claim 1, wherein analyzing the plurality of data sets comprises:
isolating a first feature in a predefined set of features;
identifying one or more data sets in the plurality of data sets including the first feature; and
determining a contribution factor for the first feature, the contribution factor indicating an impact of the first feature on the success rate.

3. The method of claim 2, wherein analyzing the plurality of data sets comprises:
isolating a second feature in the predefined set of features;
identifying one or more data sets in the plurality of data sets including the second feature; and
determining a contribution factor for the second feature, the contribution factor indicating an impact of the second feature on the success rate.

4. The method of claim 3, wherein analyzing the plurality of data sets further comprises:
identifying one or more data sets in the plurality of data sets including both the first feature and the second feature; and
determining a contribution factor for a combination of the first feature and the second feature, the contribution factor indicating an impact of the combination of the first feature and the second feature on the success rate.

5. The method of claim 4, wherein analyzing the plurality of data sets further comprises superseding the contribution factor of the first feature and the contribution factor of the second feature with the contribution factor of the combination of the first feature and the second feature.

6. The method of claim 1, wherein analyzing the plurality of data sets comprises weighting each data set in the plurality of data sets based on an identity of a submitting user.

7. The method of claim 1, wherein determining the estimated probability of print success comprises weighting the estimated probability based on an identity of a submitting user.

8. An apparatus for initiating a 3D print operation comprising:
a processor;
memory connected to the processor for storing processor executable code; and
processor executable code for configuring the processor to:
load a 3D model;
analyze the 3D model to identify one or more features in a predefined set of features, each feature in the predefined set of features associated with a contribution factor indicating an impact of the corresponding feature on a success rate when printing a 3D model including the corresponding feature;
compile the identified features into a 3D model data set;
transmit the 3D model data set to a remote system for determination of an estimated success probability;
receive an indication of success or failure subsequent to printing the 3D model; and
transmit the indication of success or failure to the remote system.

9. The apparatus of claim 8, further comprising a 3D printer connected to the processor, wherein the processor executable code further configures the processor to compile one or more features of the 3D printer into the 3D model data set.

10. The apparatus of claim 8, wherein the processor executable code further configures the processor to compile one or more properties of a print medium to be utilized in printing the 3D model into the 3D model data set.

11. The apparatus of claim 8, wherein the processor executable code further configures the processor to compile one or more features of a 3D printing process to be utilized in printing the 3D model into the 3D model data set.

12. The apparatus of claim 8, wherein the processor executable code further configures the processor to display a list of the identified features in relation to a representation of the 3D model.

13. The apparatus of claim 8, wherein the indication of success or failure corresponds to a command to abort the print process.

14. An apparatus for estimating a print success probability of a new 3D model comprising:
a processor;
a data storage element connected to the processor;
memory connected to the processor for storing processor executable code; and
processor executable code for configuring the processor to:
receive a plurality of data sets, each of the plurality of data sets comprising a list of features identified in a particular 3D model and an indication of whether or not the particular 3D model printed successfully;
store the plurality of data sets in the data storage element;
analyze the plurality of data sets to define a plurality of contribution factors, each contribution factor comprising a value indicating an impact of the corresponding feature on a success rate when printing a 3D model including the corresponding feature;
receive a new 3D model data set comprising a list of features identified in the new 3D model;
compile a set of contribution factors, each corresponding to one or more features in the new 3D model data set; and
determine an estimated probability of print success based on the compiled set of contribution factors.

15. The apparatus of claim 14, wherein analyzing the plurality of data sets comprises:
isolating a first feature in a predefined set of features;
identifying one or more data sets in the plurality of data sets including the first feature; and
determining a contribution factor for the first feature, the contribution factor indicating an impact of the first feature on the success rate.

16. The apparatus of claim 15, wherein analyzing the plurality of data sets further comprises:
isolating a second feature in the predefined set of features;
identifying one or more data sets in the plurality of data sets including the second feature; and
determining a contribution factor for the second feature, the contribution factor indicating an impact of the second feature on the success rate.

17. The apparatus of claim 16, wherein analyzing the plurality of data sets further comprises:
identifying one or more data sets in the plurality of data sets including both the first feature and the second feature; and
determining a contribution factor for a combination of the first feature and the second feature, the contribution factor indicating an impact of the combination of the first feature and the second feature on the success rate.

18. The apparatus of claim 17, wherein analyzing the plurality of data sets further comprises superseding the contribution factor of the first feature and the contribution factor of the second feature with the contribution factor of the combination of the first feature and the second feature.

19. The apparatus of claim 14, wherein analyzing the plurality of data sets comprises weighting each data set in the plurality of data sets based on an identity of a submitting user.

20. The apparatus of claim 14, wherein determining the estimated probability of print success comprises weighting the estimated probability based on an identity of a submitting user.
